(19) United States
(12) Patent Application Publication
(10) Pub. No.: US 2014/0104819 A1
(43) Pub. Date: Apr. 17, 2014

(54) MAILBOX LIGHT

(71) Applicant: Maurice H. DOWDING, Springport, MI (US)

(72) Inventor: Maurice H. DOWDING, Springport, MI (US)

(21) Appl. No.: 13/653,518

(22) Filed: Oct. 17, 2012

(51) Int. Cl. F21L 4/00; F21L 4/08

(52) U.S. Cl. 362/183; 362/191

(57) ABSTRACT

A solar powered light illuminating the interior of a mailbox in low-light conditions or whenever the door to the mailbox is opened. A mounting plate with a center aperture is attached to the top of the mailbox and is provided with resilient lugs to receive a light housing in a snap-fit relationship which is releasable for battery change operations. The light is an LED.

### FIELD OF THE INVENTION

The invention relates to devices for illuminating the interior of a mailbox and more particularly to a light which, in the preferred form, has a unique mounting structure and is charged by solar energy.

### BACKGROUND OF THE INVENTION

Conventional mailbox structures approved by the Postal Service typically have a metal container body with a front opening door attached to the body by a bottom hinge. Unless a mail load in the box is particularly large, it can be difficult to see mail in the box in low-light conditions. As a result, a number of lights have been proposed for the illumination of a mailbox interior and/or address numbers attached to a mailbox. Examples are shown in U.S. Pat. No. 6,629,634 to Simmons and U.S. Pat. No. 5,522,540 to Surman.

### SUMMARY OF THE INVENTION

The present invention comprises a light, preferably battery-powered with a solar cell for charging the battery, to illuminate the interior of a mailbox in low-light conditions or any time the mailbox is opened, wherein an improved mounting structure is provided for simply and expeditiously attaching the charging unit and light to the top of a conventional mailbox. The mounting structure also facilitates removing the solar cell unit for battery replacement purposes.

In general, the light disclosed herein comprises in combination, a baseplate which is adapted to be mounted on the top of the mailbox and which has a set of resilient lugs projecting upwardly therefrom; a light housing adapted to carry a battery; and, in the preferred embodiment, a solar cell for charging purposes is configured in such a way as to be snap-fastened to the base by way of the resilient lugs. The housing carries a light which projects downwardly through an aperture in the baseplate and into the interior of the mailbox through a hole which must be drilled or otherwise formed in a conventional mailbox as part of the mounting procedure.

In the preferred form, the light is a low power-consuming LED and the baseplate is either pre-conformed to fit a specific top contour or readily conformable to accommodate an arched top surface of the mailbox. In one embodiment disclosed herein, the baseplate has a central flat surface for mounting the resilient lugs which are used to attach the charging unit to the baseplate and, integral with the flat surface, at least one set of bent or bendable tabs which are non-co-planar with the flat surface so as to accommodate the contour of either a flat or arched mailbox design. These tabs may have screw holes preformed therein for attachment purposes. Of course various alternatives to screws are also available including two-sided tape and other forms of adhesives and fasteners.

Other advantages, features and characteristics of the present invention, as well as methods of operation and functions of the related elements of the structure, and the combination of parts and economies of manufacture, will become more apparent upon consideration of the following detailed description and the appended claims with reference to the accompanying photographs, the latter being briefly described hereinafter.

### BRIEF SUMMARY OF THE DRAWINGS

The description herein makes reference to the accompanying drawings wherein like reference numerals refer to like parts throughout the several views and wherein:

FIG. 1 is a perspective view of a first baseplate embodiment;

FIG. 2 is a perspective view of a second baseplate embodiment;

FIG. 3 is a perspective view of a conventional arched top mailbox with a hinged door and showing how an embodiment of the inventive light is attached thereto;

FIG. 4 is a perspective view of the mailbox of FIG. 3 with the light fully assembled to the mailbox;

FIG. 5 is a perspective view of another baseplate embodiment with flat, but bendable mounting tabs;

FIG. 6 is a perspective view of the baseplate embodiment of FIG. 5 with mounting tabs bent to conform to the top of an arched top mailbox;

FIG. 7 is a view of a mailbox showing how a light using the baseplate of FIG. 6 is attached;

FIG. 8 is a perspective view of a fully assembled mailbox and light combination according to the design of FIGS. 6 and 7;

FIG. 9 is a perspective view of still another baseplate;

FIG. 10 shows how the baseplate of FIG. 9 is attached;

FIG. 11 is a perspective view of a fully assembled mailbox using the embodiment of FIG. 10;

FIG. 12 is a perspective view of a mailbox from a front angle with the door opened to show how the light which is part of the light housing projects into the interior of the mailbox;

FIG. 13 is a side sectional view of a fully assembled mailbox, baseplate and housing according to the embodiments of FIGS. 6 and 7 showing how the bendable tabs of the baseplate are fastened by screws to the arched top of the mailbox; and

FIG. 14 is a side view, partly in section, of an optional feature in which the light is turned on by means of a plunger-type switch which is activated upon opening the mailbox door.

### DETAILED DESCRIPTION OF THE ILLUSTRATIVE EMBODIMENTS

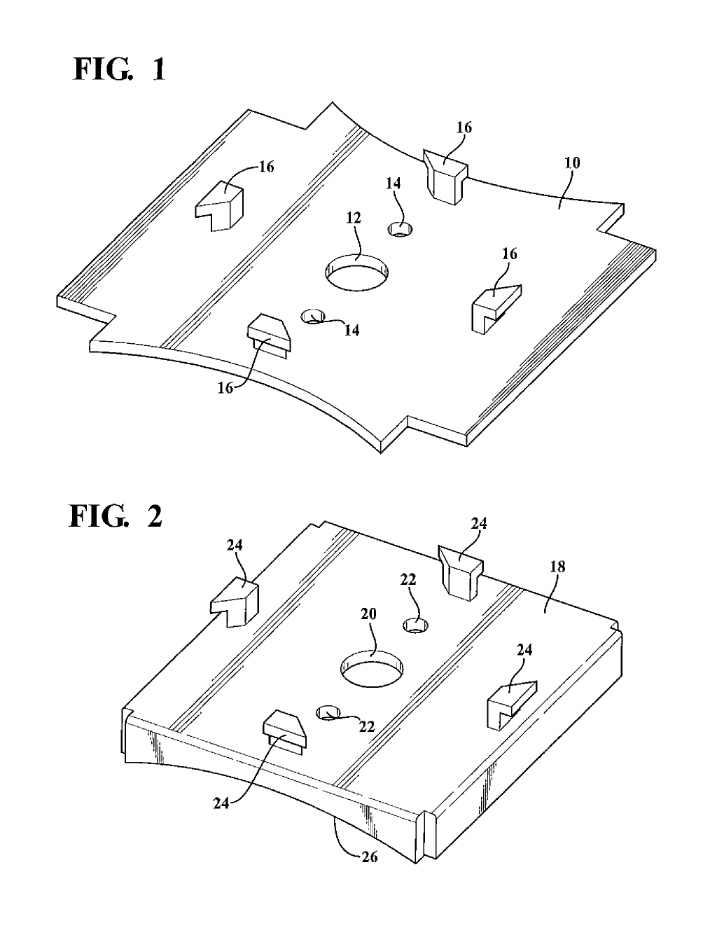

Referring to FIG. 1, there is shown a baseplate 10 which may be made preferably of plastic or metal, in such density and thickness as to provide a rigid structure. The baseplate 10 is generally planar but has contoured peripheral edges. A center aperture 12 is provided for purposes to be described. Flanking the aperture 12 are screw holes 14 which allow the baseplate to be attached by screws or bolts to the top of a mailbox.

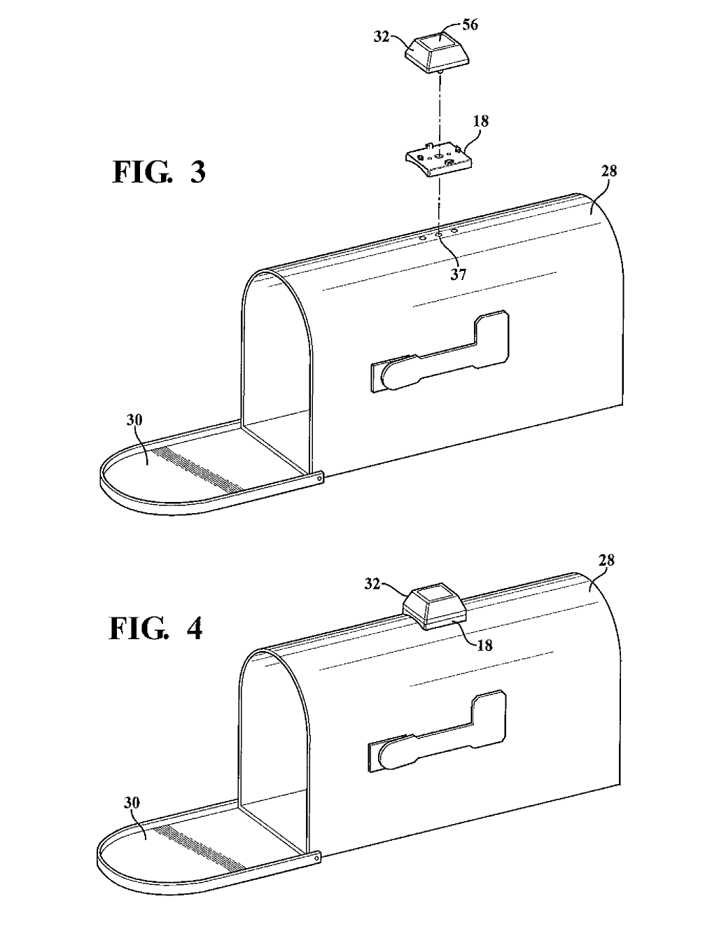

Upstanding resilient lugs 16 are provided in two opposed pairs symmetrically mounted around the center aperture 12 and toward the outer peripheral edge of the baseplate 10 to receive in a snap-fit relationship a light housing hereinafter described with reference to FIGS. 3, 4, 8, 9, 11, 12, 13 and 14. The lugs have outwardly and downwardly cambered top surfaces.

FIG. 2 shows an alternative baseplate 18, again with a generally planar top surface having a center aperture 20 and screw holes 22 for mounting purposes. Resilient lugs 24 are arranged symmetrically in pairs surrounding the center aperture 20 to receive and secure a light housing as hereinafter described. A distinguishing feature of the baseplate 18 is the curved bottom surface 26 which is designed to correspond essentially to the radius of the top of an arched mailbox 28 shown in FIGS. 3 and 4.

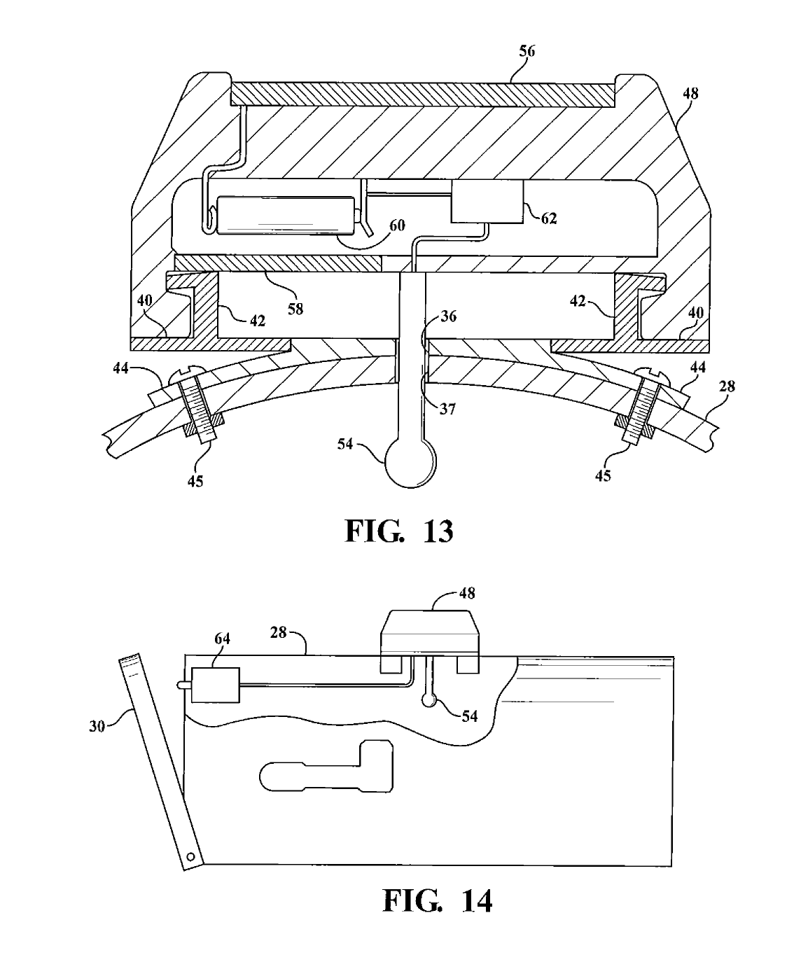

Looking to FIGS. 3 and 4, the baseplate 18 is shown in FIG. 3 ready to receive a pre-fabricated light housing 32 having a solar panel 56 in the top surface thereof for charging the battery as shown in FIG. 13 which powers a light 54, also shown in FIG. 13, projecting downwardly through a hole 37 which is formed in the top of the mailbox 28 as part of the installation process. The mailbox 28 has a conventional hinged front door 30 for gaining access to the interior of the mailbox.

As shown in FIG. 4, an illustrative completed assembly involves mounting the baseplate 18 to the top of the mailbox by means of screws which extend through the holes 22 into the mailbox 28. These may be self-tapping screws or short bolts, in which case additional mounting holes must be drilled into the arched top of the mailbox 28. The light housing 32 is clipped onto the baseplate 18 by way of the resilient lugs 24 so that the entire structure is securely fastened to the top of the mailbox 28 in such a way that it cannot be turned or rotated. A seal between the light housing 32 and the baseplate 18 may be provided.

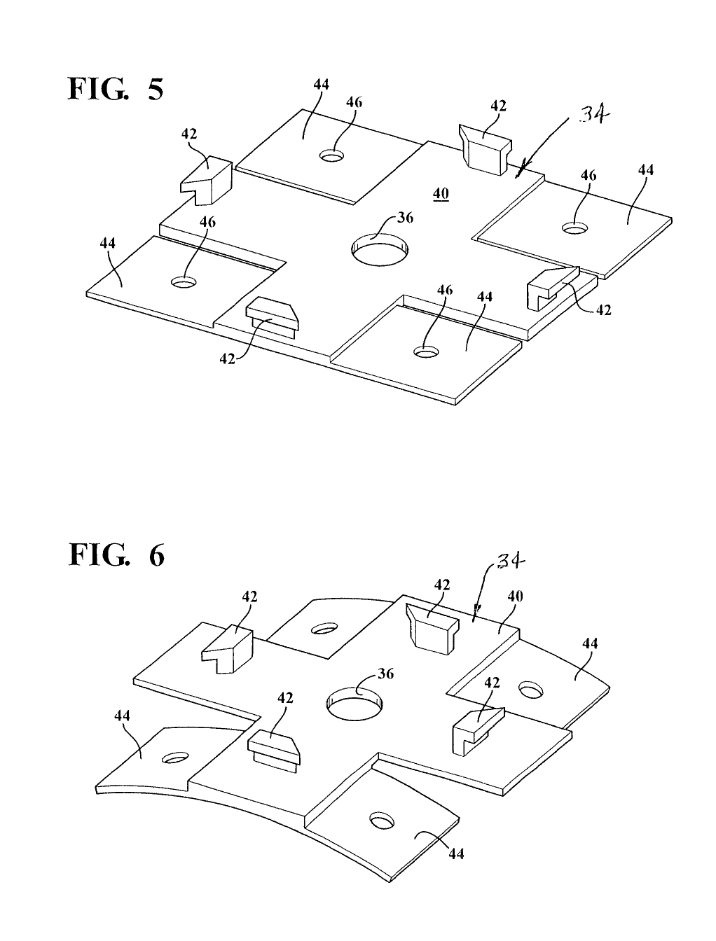

Referring to FIGS. 5 and 6, there is shown a still further embodiment of the invention in the form of a baseplate 34 which is preferably made of metal, the material of choice being aluminum, not only because it is light but also because it is relatively easily bent or formed into the configuration shown in FIG. 6.

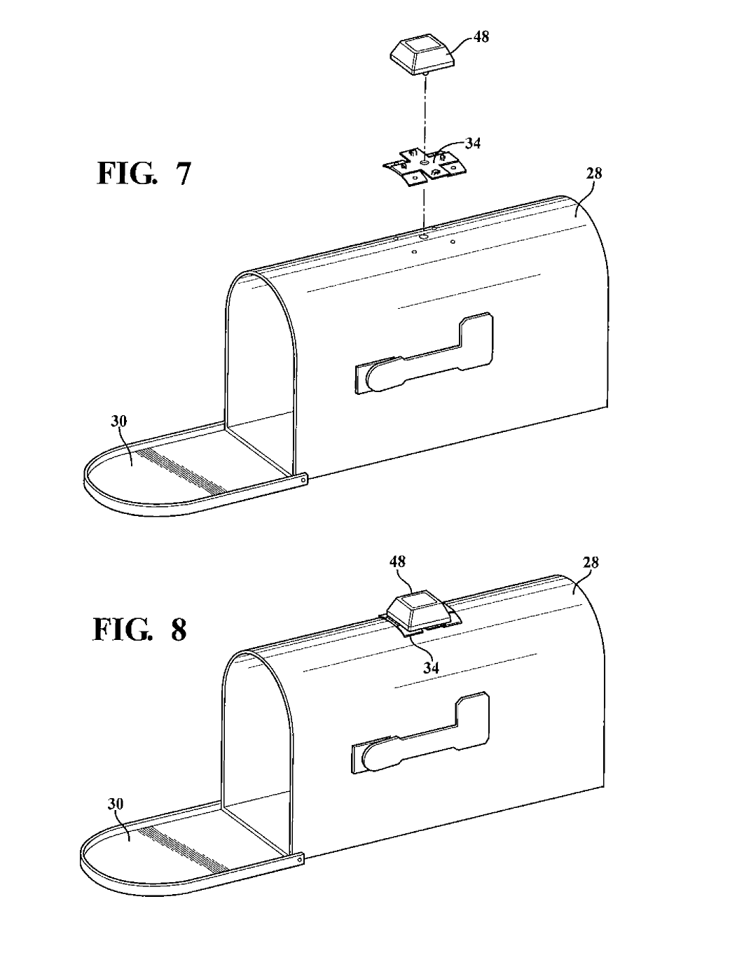

The baseplate 34 has a cruciform center level 40 with a center aperture 36 to allow a light to pass therethrough. Resilient lugs 42 for securing a light housing to the plate 34 in a snap-fit relationship as described above are provided. In addition, mounting tabs 44 are provided in pairs and each of the mounting tabs has a center screw hole 46 formed therein to accept self-tapping screws or short bolts to attach the mounting plate 34 to the top of an arched mailbox. The tabs 44 have top surfaces which lie below the top surface 40; i.e., the top surfaces of the tabs 44 are not co-planar with the top surface 40 of the cruciform center of the baseplate 34. The tabs 44 may be left flat for a flat-top box or bent downwardly during the attachment process to conform to the top of an arched top mailbox 28 as shown in FIGS. 7 and 8, after which the tabs are secured by screws to the top of the mailbox. In this case, five holes must be drilled in the mailbox, one for a light and four for bolts or screws in the tabs 44.

FIG. 7 shows the baseplate 34 and a snap-on light housing 48 in exploded form relative to the top surface of a conventional metal mailbox 28 while FIG. 8 shows the entire assembly with the baseplate 34 fully attached to the mailbox and the light housing 48 snap-fit onto the baseplate 34.

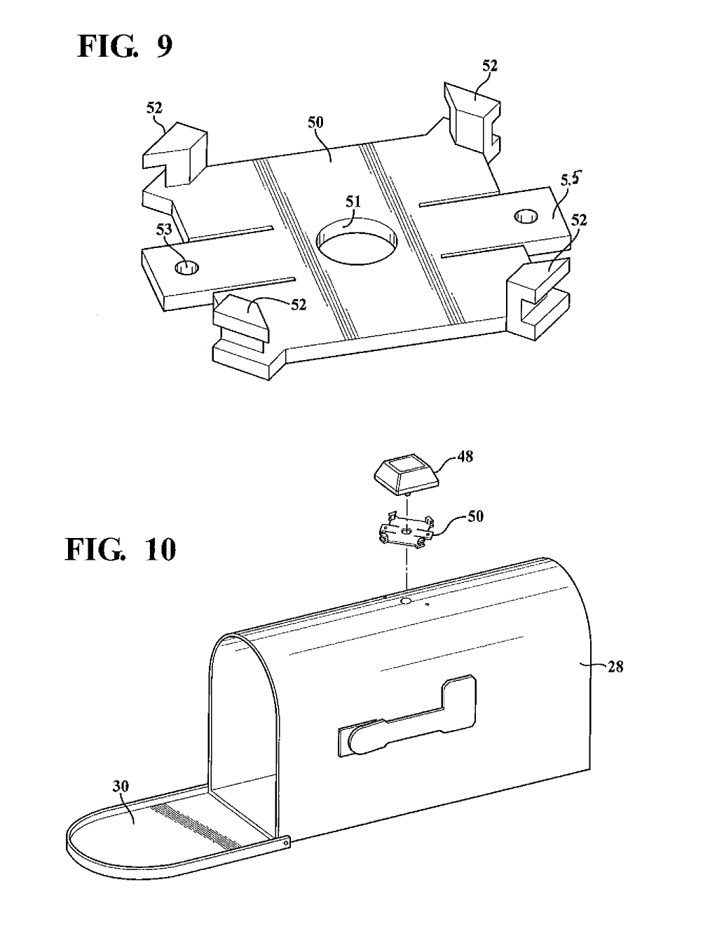

FIG. 9 shows a still further embodiment of the invention in the form of a baseplate 50 which is generally square in configuration and has a center aperture 51 flanked by tabs 55 with screw holes 53. Resilient lugs 52 are formed in the corners of the baseplate 50 to receive a light housing 48 in snap-fit relationship as shown in FIGS. 10, 11 and 12. Tabs 55 may remain flat for flat top boxes or be bent for curved top boxes. Screw holes 53 are formed in them to fasten the plate to the box.

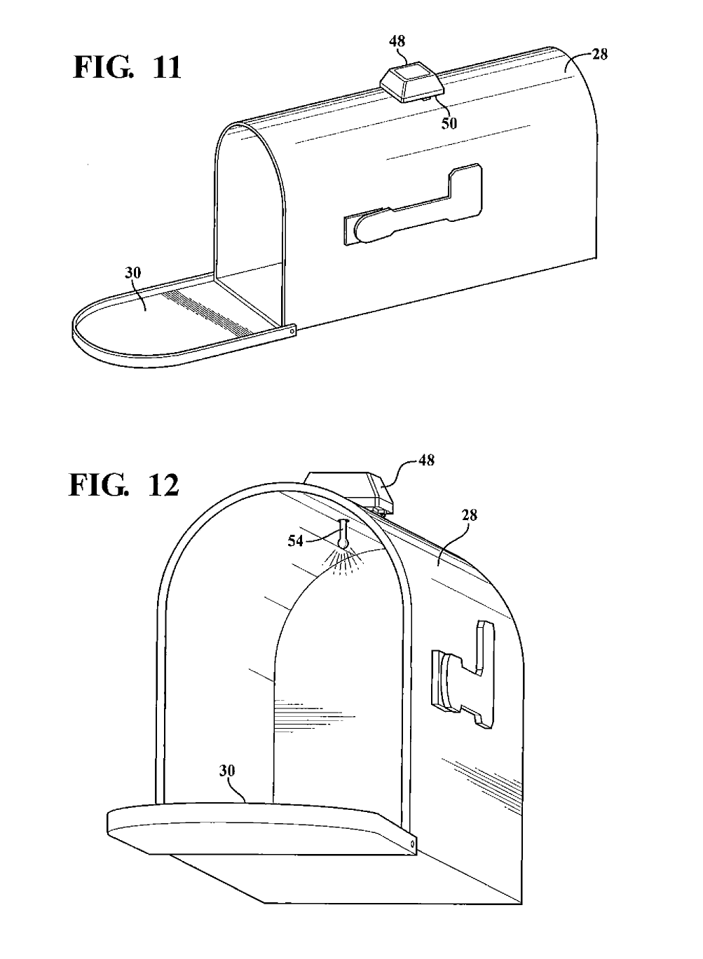

FIG. 10 is an exploded view showing the baseplate 50 and light housing 48 in the assembly process prior to the drilling of screw holes in the mailbox 28. FIG. 11 is an illustrative, fully assembled view.

FIG. 12 shows how an LED light 54 on the end of a downwardly-projecting stalk projects from the light housing 48 through the aperture 51 in the baseplate and a drilled hole in the mailbox 28 so as to illuminate the interior of the mailbox during the time mail is being extracted by the proprietor of the mailbox.

FIG. 13 shows an illustrative arrangement in detail utilizing the baseplate of FIG. 5 wherein the tabs 44 have been bent so as to follow the contour of the mailbox top 28 and further wherein through bolts 45 have been used to secure the tabs in place. The light housing 48 is shown to comprise a top-mounted solar panel 56 which is connected to charge a rechargeable NiCad battery 60 which is connected through a light responsive switch 62 to the light 54 which projects downwardly through the apertures 36, 37 into the interior of the mailbox 28. The resilient lugs 42 which are formed as part of the baseplate project upwardly into a cavity 58 formed within the bottom surface of the light housing 48. The resilient lugs 42 are sufficiently flexible to accommodate the undercut in the cavity 58 and also to release the light housing 48 from the baseplate surface 40 in the event it is necessary or desirable to change the battery. The top surfaces of the lugs are cambered to allow the housing 48 to snap over the legs during installation.

FIG. 14 shows in side view a mailbox 28 having a door 30 wherein a plunger-type switch 64 has been mounted by a suitable bracket and screws just inside of the door 30 so as to provide a turn-on function to the light 54 which is part of and attached to the light housing 48 whenever the door 30 is open, regardless of the ambient light conditions. The light housing 48 nevertheless, is provided with a solar cell 56 as shown in FIG. 13 to recharge a battery which is mounted within the light housing 48 in the manner described above.

It will be understood that various changes and modifications as well as combinations of the various features as described can be used in a particular embodiment and that such changes and modifications can be apparent to a person of ordinary skill in the art.

While the invention has been described in connection with what is presently considered to be the most practical and preferred embodiment, it is to be understood that the invention is not to be limited to the disclosed embodiments but, on the contrary, is intended to cover various modifications and equivalent arrangements included within the spirit and scope of the appended claims, which scope is to be accorded the broadest interpretation so as to encompass all such modifications and equivalent structures as is permitted under the law.

1. A mailbox light comprising:
a baseplate adapted to be mounted on the top outside surface of a mailbox and having an aperture therethrough and a set of resilient lugs projecting therefrom; and
a light housing adapted to be snap-fastened to the baseplate by way of said set of resilient lugs and having a surface which mates with said baseplate such that the entirety of said housing and baseplate are outside of the mailbox interior when mounted;
said housing accommodating therein a battery and further having a light projecting from said surface so as to extend downwardly through said aperture and into said mailbox when said baseplate and said housing are mounted together thereon.

2. A mailbox light as defined in claim 1 wherein the housing carries a solar cell connected to charge said battery.

3. A mailbox light as defined in claim 2 wherein the light is an LED.

4. A mailbox light as defined in claim 2 wherein the baseplate has an arcuate undersurface to conforming lie against a mailbox having an arched top outside surface.

5. A mailbox light as defined in claim 1 further comprising a switch turning the light on and off.

6. A mailbox light as defined in claim 5 wherein the switch is operated by a mailbox door.

7. A mailbox light as defined in claim 1 wherein the baseplate comprises a generally flat upper surface supporting said set of resilient lugs and in surrounding relationship to said set of resilient lugs, at least one set of tabs adapted to be conformed to the arched top of a conventional mailbox.

8. A mailbox light as defined in claim 7 wherein screw holes are formed in said set of tabs.

9. A mailbox light comprising:
a baseplate adapted to be mounted to a mailbox and having an aperture therethrough and a set of resilient lugs projecting therefrom; and
a light housing adapted to be snap-fastened to the baseplate by way of said set of resilient lugs and having a surface which mates with said baseplate;
said housing accommodating therein a battery and further having a light projecting from said surface so as to extend through said aperture and into a mailbox when said baseplate and said housing are mounted together thereon,
wherein the baseplate comprises a cruciform top surface having a center aperture and, in surrounding relationship to said cruciform surface, but non-co-planar therewith, two sets of bendable tabs for attachment of said baseplate to the arched top surface of a conventional mailbox.

10. A mailbox light as defined in claim 9 wherein the set of resilient lugs are arranged in opposed pairs.

11. A light for illuminating the interior of a mailbox of the type having an arcuate outside top surface comprising:
a base plate adapted to be mounted to the top outside surface of said mailbox and having attachment elements conformable to said arcuate outside surface;
said base plate further having a relatively top flat surface and a set of resilient lugs projecting upwardly from said flat top surface; and
a light housing adapted to be snap-fastened to the top surface of the baseplate by way of said resilient lugs such that the entirety of the housing and baseplate are outside of the mailbox interior when mounted thereon;
said housing accommodating therein a battery and further having a light projecting downwardly from the baseplate and housing so as to extend fully into the interior of said mailbox when said baseplate are mounted together thereon.
